(19) United States
(12) Patent Application Publication
(10) Pub. No.: US 2003/0212799 A1
(43) Pub. Date: Nov. 13, 2003

(54) System for confirming the presence at home

(76) Inventor: Yoshinobu Sera, Kanagawa (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/434,276

(22) Filed: May 9, 2003

(30) Foreign Application Priority Data
May 10, 2002 (JP) 2002-135733

(51) Int. Cl. G06F 15/16

(52) U.S. Cl. 709/227

(57) ABSTRACT

A system for offering a delivery service to a delivery destination includes: at least one subscriber's terminal accessible to a communication network; and at least one deliverer's terminal accessible to the communication network. The at least one subscriber's terminal includes a first function unit for allowing a subscriber to set, in the at least one subscriber's terminal, a presence-at-destination information which identifies whether the subscriber is present or absent at the delivery destination. The at least one deliverer's terminal includes a second function unit for recognizing whether the subscriber is present or absent at the delivery destination, based on the presence-at-destination information.

### BACKGROUND OF THE INVENTION

1. Field of the Invention

The present invention relates to a system for confirming the presence at home, and more particularly to a system for confirming whether any person is present or absent at a home which is a delivery destination.

All of patents, patent applications, patent publications, scientific articles and the like, which will hereinafter be cited or identified in the present application, will, hereby, be incorporated by references in their entirety in order to describe more fully the state of the art, to which the present invention pertains.

2. Description of the Related Art

A deliverer of a delivery company goes to a home as a delivery destination for delivering any article or any service. If any person is present at the home, then the deliverer could deliver the article or service to the person at the hole. If any person is absent at the home, then the deliverer leaves, at the home, a notice to the effect that the deliverer could not deliver the article or service to the home as the delivery destination because any person was absent at the hole when the deliverer visited the home, and therefore, the delivery company sill leaves the article or service in their care. This means that the deliverer could not know whether any person is present or absent at the delivery destination home unless the deliverer goes to the delivery destination home. It is unavoidable that the deliverer goes to the delivery destination home, at which any person is absent. This deteriorates the efficiency of delivery work.

In the above circumstances, the development of a novel system for confirming whether any person is present or absent at the delivery destination free without going to the delivery destination is desirable.

### SUMMARY OF THE INVENTION

Accordingly, it is an object of the present invention to provide a novel system for confirming whether any person is present or absent at the delivery destination without going to the delivery destination.

It is a further object of the present invention to provide a novel system for surely notifying the delivery destination that a deliverer or a delivery company has a delivery-requested article or service which is to be delivered to the delivery destination without rendering the deliverer to go to the delivery destination.

The present invention provides a system for offering a delivery service to a delivery destination. The system includes: at least one subscriber's terminal accessible to a communication network; and at least one deliverer's terminal accessible to the communication network, wherein the at least one subscriber's terminal includes a first function unit for allowing a subscriber to set, in the at least one subscriber's terminal, a presence-at-destination information which identifies whether the subscriber is present or absent at the delivery destination, and wherein the at least one deliverer's terminal includes a second function unit for recognizing whether the subscriber is present or absent at the delivery destination, based on the presence-at-destination information.

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1 is a block diagram illustrative of a system for confirming the presence at home in the first embodiment of the present invention.

FIG. 2 is a flow chart illustrate of operations of the system shown in FIG. 1.

### DETAILED DESCRIPTION OF THE PREFERRED EMBODIMENTS

A first aspect of the present invention is a system for offering a delivery service to a delivery destination. The system includes: at least one subscriber's terminal accessible to a communication network; and at least one deliverer's terminal accessible to the communication network, wherein the at least one subscriber's terminal includes a first function unit for allowing a subscriber to set, in the at least one subscriber's terminal, a presence-at-destination information which identifies whether the subscriber is present or absent at the delivery destination, and wherein the at least one deliverer's terminal includes a second function unit for recognizing whether the subscriber is present or absent at the delivery destination, bases on the presence-at-destination information.

It is preferable that the at least one deliverer's terminal further includes a third function unit for sending an inquiry for inquiring about the presence-at-destination information to the subscriber's terminal, and that the subscriber's terminal further includes a fourth function unit for sending the presence-at-destination information as set by the first function unit to the deliverer's terminal in response to the inquiry from the deliverer's terminal.

It is further preferable that the system further includes a delivery information processor accessible to the communication network, and the deliverer's terminal further includes a fifth function unit for sending a notice of outstanding of a requested delivery service to the delivery destination and the delivery information processor.

It is furthermore preferable that the subscriber's terminal further includes a sixth function unit for sending, to the delivery information processor, a request for offering a requested but outstanding delivery service to the delivery destination, in response to the notice from the deliverer's terminal.

It is moreover preferable that the delivery information processor includes a seventh function unit for collating the request with the notice, to confirm a correspondence between the request and the notice.

It is still further preferable that the delivery information processor includes an eighth function unit for sending, to the subscriber's terminal, a delivery schedule which notify when the deliverer plans to offer the outstanding delivery service at the delivery destination.

It is yet further preferable that the delivery information processor includes a ninth function unit for sending delivery-destination-related data to the deliverer's terminal, to enable the deliverer's terminal to send the inquiry to the subscriber's terminal based on the delivery-destination-related data.

The following embodiments are typical examples for practicing the foregoing aspects of the present invention. Although the subject matters of the present invention have been described in details, the following additional descriptions in one or more typical preferred embodiments or examples will be made with reference to the drawings for making it easy to understand the typical modes for practicing the foregoing aspects of the present invention.

First Embodiment:

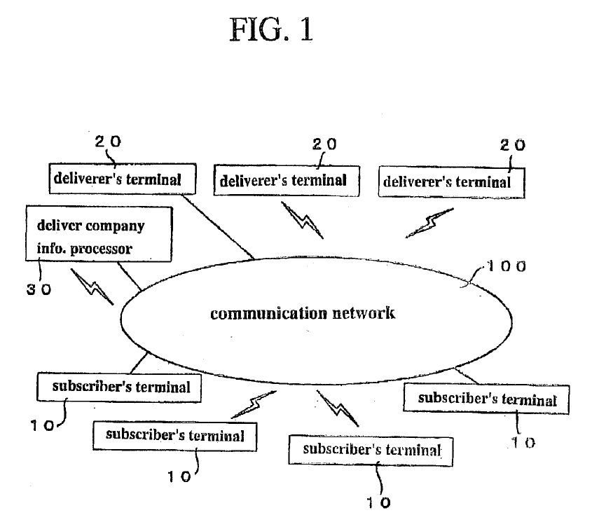

A first embodiment according to the present invention will be described in detail with reference to the drawings. FIG. 1 is a block diagram illustrative of a system for confirming the presence at home in the first embodiment of the present invention. The system includes a plurality of presence-at-home-confirming terminals 10, delivery company's terminals 20 and a delivery company's information processor 30, wherein the terminals 10 and 20 and the processor 30 are connected to each other through a communication network 100. Some of the presence-at-home-confirming terminals 10 have a wireless-connection to the communication network 100, and others of the presence-at-home-confirming terminals 10 have a wired-connection to the communication network 100. Some of the delivery company's terminals 20 have a wireless-connection to the communication network 100, and others of the delivery company's terminals 20 have a wired-connection to the communication network 100. The wireless-connection is represented by a zigzag broad line. The wired-connection is represented by a straight real line.

Each of the presence-at-home-confirming terminals 10 may be allocated at each delivery destination, for example, each subscriber's home. The subscriber is of the present system. The presence-at-home-confirming terminal 10 may be realized by an information processor such as a personal computer or an advanced telephone with a simplified computer-function, wherein the information processor is capable of having a wired-connection or a wire-less connection to the communication network 100. A user, who is a subscriber and intends to receive a delivery service at a delivery destination, sets either identification of the presence or the absence at the delivery destination home in the presence-at-home-confirming terminal 10.

The presence-at-home-confirming terminal 10 has a function of sends the delivery company's terminal 20 a currently set identification of the presence or the absence at the delivery destination home in response to a received inquiry signal for inquiring the presence or the absence at the delivery destination home, wherein the inquiry signal has been transmitted from the delivery company's terminal 20.

The presence-at-home-confirming terminal 10 also has another function of receiving a notice of communication from the delivery company's terminal 20 if the identification of the absence is set in the presence-at-home-confirming terminal 10.

The presence-at-home-confirming terminal 10 also has still another function of transmitting and receiving data related to a request for delivery to and from the delivery company's information processor 30.

Each of the delivery company's terminals 20 may be possessed by each deliverer of the delivery company. The delivery company's terminal 20 may be realized by an information processor such as a personal computer or an advanced telephone with a simplified computer-function, wherein the information processor is capable of having a wired-connection or a wire-less connection to the communication network 100.

The delivery company's terminal 20 has a function of receiving data related to a nominated deliverer from the delivery company's information processor 30 and storing the nominated-deliverer-related data therein.

The delivery company's terminal 20 also has another function of designating a delivery destination belonging to a delivery area.

The delivery company's terminal 20 also has still another function of sending an inquiry signal for inquiring the presence or the absence at a delivery destination home through the communication network 100 to the presence-at-home-confirming terminal 10 allocated at the delivery destination home.

The delivery company's terminal 20 also has yet another function of recognizing the contents of reply to the sent inquiry signal as transmitted from the presence-at-home-confirming terminal 10, wherein the contents of reply is the identification of the presence or the absence at the delivery destination home.

The delivery company's terminal 20 also has further another function of displaying a present-delivery destination home, for which the contents of reply are the presence at home, as well as an absent-delivery destination home, for which the contents of reply are the absence at home, and removing the absent-delivery destination home from the lest of delivery destinations.

The delivery company's terminal 20 also has a further function of sending a notice of outstanding of the requested delivery service to the absent-delivery destination home and the delivery company's information processor 30, wherein the notice of outstanding of the requested delivery service is to notify that due to the absence at home, the delivery company sill leaves the requested delivery service in their care.

The delivery company's information processor 30 may be allocated to the delivery company. The delivery company's information processor 30 may also be realized by an information processor such as a personal computer or an advanced telephone with a simplified computer-function, wherein the information processor is capable of having a wired-connection or a wire-less connection to the communication network 100.

The delivery company's information processor 30 has a function of storing and managing delivery schedule data, absence-related information, and re-delivery-request-related data.

The delivery company's information processor 30 has another function of collating the information from the presence-at-home-confirming terminal 10 to the absence-related information.

The communication network 100 may comprise either a wired-network or a wire-less network for providing inter-connections among the presence-at-home-confirming terminal 10, the delivery company's terminals 20, and the delivery company's information processor 30 and for allowing data transmissions among the presence-at-home-confirming terminal 10, the delivery company's terminals 20, and the delivery company's information processor 30.

Each subscriber processes each presence-at-home-confirming terminal 10, so that the deliverer of the delivery company operates the delivery company's terminal 20 to send the inquiry signal for inquiring the presence or the absence at a delivery destination home through the communication network 100 to one or more presence-at-home-confirming terminals 10 allocated to delivery destination homes located in a delivery area. The deliverer of the delivery company receives a reply to the sent inquiry signal and recognize the contents of the received reply, for example, the identification of the presence or the absence at the delivery destination home.

If the contents of the received reply is to identify the presence at home, then the deliverer of the delivery company goes to the delivery destination home for providing the delivery services. If the contents of the received reply is to identify the absence at home, then the deliverer of the delivery company may operate the delivery company's terminal 20 to send a notice of outstanding of the requested delivery service to the presence-at-home-confirming terminal 10 of the absent-delivery destination home and the delivery company's information processor 30, wherein the notice of outstanding of the requested delivery service is to notify that due to the absence at home, the delivery company sill leaves the requested but outstanding delivery service in their care.

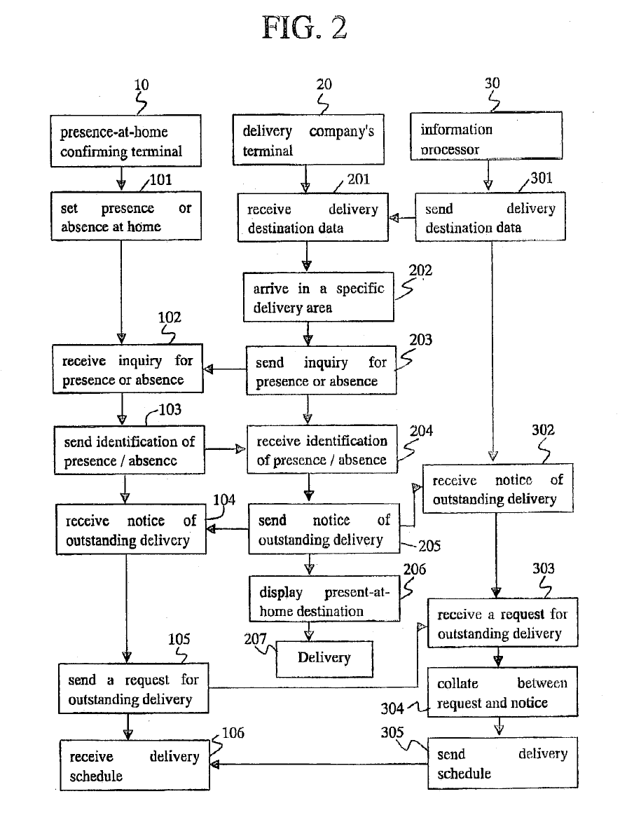

FIG. 2 is a flow chart illustrate of operations of the system shown in FIG. 1.

In step 101, a subscriber of the system sets either identification of the presence or the absence at the delivery destination home in a presence-at-home-confirming terminal 10 possessed by this subscriber.

In step 301, the delivery company's information processor 30 sends delivery-destination-related data to the delivery company's terminal 20.

In step 201, the delivery company's terminal 20 receives the delivery-destination-related data from the delivery company's information processor 30.

In step 202, based on the received delivery-destination-related data, the deliverer of the delivery company moved to a delivery area, in which the delivery destination home is located.

In step 203, the delivery company's terminal 20 sends an inquiry signal for inquiring the presence or the absence at the designated delivery destination home through the communication network 100 to the presence-at-home-confirming terminal 10 allocated to the designated delivery destination home.

In step 102, the presence-at-home-confirming terminal 10 receives the inquiry signal for inquiring the presence or the absence at the designated delivery destination home from the delivery company's terminal 20.

In step 103, the presence-at-home-confirming terminal 10 sends, to the delivery company's terminal 20, the above set identification of the presence or the absence at the delivery destination home in response to the received inquiry signal as transmitted from the delivery company's terminal 20.

In step 204, the delivery company's terminal 20 recognizes the contents of reply to the sent inquiry signal as transmitted from the presence-at-home-confirming terminal 10, wherein the contents of reply is the identification of the presence or the absence at the delivery destination home.

If the contents of the received reply is to identify the absence at home, then in step 205, the delivery company's terminal 20 sends a notice of outstanding of the requested delivery service to the presence-at-home-confirming terminal 10 of the absent-delivery destination home and the delivery company's information processor 30, wherein the notice of outstanding of the requested delivery service is to notify that due to the absence at home, the delivery company sill leaves the requested but outstanding delivery service in their care. The notice of outstanding of the requested delivery service is also accompanied with data related to the outstanding delivery services. This reduces the subscriber's work for confirmation of the case of the outstanding delivery services.

In step 206, the delivery company's terminal 20 also displays a list of the present-delivery destination home, for which the contents of reply are the presence at home.

If the contents of the received reply is to identify the presence at home, then in step 207, based on the list of the present-delivery destination home, the deliverer of the delivery company goes to the delivery destination home for providing the delivery services.

In step 104, the presence-at-home-confirming terminal 10 receives the notice of outstanding of the requested delivery service from the delivery company's terminal 20.

In step 302, the delivery company's information processor 30 also receives the notice of outstanding of the requested delivery service from the delivery company's terminal 20.

In step 105, the presence-at-home-confirming terminal 10 sends, to the delivery company's information processor 30, a request for providing the outstanding delivery service to the delivery destination home.

In step 303, the delivery company's information processor 30 receives, from presence-at-home-confirming terminal 10, the request for providing the outstanding delivery service to the delivery destination home.

In step 304, the delivery company's information processor 30 collates the data accompanied to the request for providing the outstanding delivery service, which have been transmitted from the presence-at-home-confirming terminal 10, to the data accompanied to the notice of outstanding of the requested delivery service, which have been received in the above step 302.

If the delivery company's information processor 30 verified the correspondence of the data, then in step 305, the delivery company's terminal 20 sends, to the presence-at-home-confirming terminal 10, a delivery schedule for when the deliverer of the delivery company plans to go to the delivery destination home for providing the delivery services.

The delivery company's terminal 20 sends the notice of outstanding of the requested delivery service to the presence-at-home-confirming terminal 10 of the absent-delivery destination home and the delivery company's information processor 30, in order to reduce the subscriber's work for confirmation of the case of the outstanding delivery services.

In step 106, the presence-at-home-confirming terminal 10 receives the delivery schedule from the delivery company's information processor 30, so that the subscriber could know when the deliverer of the delivery company plans comes for providing the delivery services.

The above described novel system allows the deliverer of the delivery company to confirm whether any person is present or absent at the delivery destination without rendering the deliverer go to the delivery destination, and also to ensure that the subscriber receives the notice of outstanding of the requested delivery service without rendering the deliverer go to the delivery destination.

Although the invention has been described above in connection with several preferred embodiments therefor, it will be appreciated that those embodiments have been provided solely for illustrating the invention, and not in a limiting sense. Numerous modifications and substitutions of equivalent materials and techniques will be readily apparent to those skilled in the art after reading the present application, and all such modifications and substitutions are expressly understood to fall within the true scope and spirit of the appended claims.

What is claimed is:

1. A system for offering a delivery service to a delivery destination, said system including:
at least one subscriber's terminal accessible to a communication network; and
at least one deliverer's terminal accessible to said communication network,
wherein said at least one subscriber's terminal includes a first function unit for allowing a subscriber to set, in said at least one subscriber's terminal, a presence-at-destination information which identifies whether said subscriber is present or absent at said delivery destination, and
wherein said at least one deliverer's terminal includes a second function unit for recognizing whether said subscriber is present or absent at said delivery destination, based on said presence-at-destination information.

2. The system as claimed in claim 1,
wherein said at least one deliverer's terminal further includes a third function unit for sending an inquiry for inquiring about said presence-at-destination information to said subscriber's terminal, and
wherein said subscriber's terminal further includes a fourth function unit for sending said presence-at-destination information as set by said first function unit to said deliverer's terminal in response to said inquiry from said deliverer's terminal.

3. The system as claimed in claim 2, further including:
a delivery information processor accessible to said communication network,
wherein said deliverer's terminal further includes a fifth function unit for sending a notice of outstanding of a requested delivery service to said delivery destination and said delivery information processor.

4. The system as claimed in claim 3,
wherein said subscriber's terminal further includes a sixth function unit for sending, to said delivery information processor, a request for offering a requested but outstanding delivery service to said delivery destination, in response to said notice from said deliverer's terminal.

5. The system as claimed in claim 4,
wherein said delivery information processor includes a seventh function unit for collating said request with said notice, to confirm a correspondence between said request and said notice.

6. The system as claimed in claim 5,
wherein said delivery information processor includes an eighth function unit for sending, to said subscriber's terminal, a delivery schedule which notify when said deliverer plans to offer said outstanding delivery service at said delivery destination.

7. The system as claimed in claim 6,
wherein the delivery information processor includes a ninth function unit for sending delivery-destination-related data to said deliverer's terminal, to enable said deliverer's terminal to send said inquiry to said subscriber's terminal based on said delivery-destination-related data.
